(19) United States
(12) Patent Application Publication
(10) Pub. No.: US 2008/0126167 A1
(43) Pub. Date: May 29, 2008

(54) INVITEE-PARTICIPANT MATCHING SYSTEM FOR MEETING SCHEDULING

(75) Inventor: Adenuga Babatunde SOLARU, Irvine, CA (US)

Correspondence Address: CALFEE HALTER & GRISWOLD, LLP, 800 SUPERIOR AVENUE, SUITE 1400, CLEVELAND, OH, 44114, US

(73) Assignee: MID-AMERICA CONSULTING GROUP, Cleveland, OH (US)

(21) Appl. No.: 11/876,898

(22) Filed: Oct. 23, 2007

Related U.S. Application Data
(60) Provisional application No. 60/853,937, filed on Oct. 24, 2006.

(51) Int. Cl. G06Q 10/00

(52) U.S. Cl. 705/8

(57) ABSTRACT

A system that schedules a meeting with a meeting invitee includes a database that is configured to store records associated with potential meeting participants that meet one or more pre-qualification criteria. A meeting notifier provides notice regarding a future meeting to the potential meeting participants having records in the database. A participant selector applies one or more post-qualification criteria to potential meeting participants who respond to the notice and a meeting scheduler places selected participants on a meeting schedule.

### CROSS-REFERENCE TO RELATED APPLICATIONS

This application claims the benefit of U.S. Provisional Patent Application Ser. No. 60/853,937, entitled “Buyer-Supplier Matching for Meeting Scheduling,” filed on Oct. 24, 2006, and which is incorporated herein by reference in its entirety for all purposes to the extent that it does not conflict with the contents hereof.

### BACKGROUND

In the course of business, many hours can be consumed scheduling and attending meetings. Often, much time is spent identifying, contacting, and scheduling the correct participants.

For example, a large portion of working hours for purchasing agents and buyers is spent managing suppliers. For example, in order to get price quotes on a certain product from existing suppliers and recruit new suppliers, many logistical hurdles are involved. First, the buyer must collect a pool of suppliers that may be able to supply the product. Then the buyer must contact the suppliers and coordinate schedules to arrange the meetings. Because the buyer may have limited information about a supplier beyond personal knowledge from previous interactions, the buyer may not know whether the supplier can meet the buyer's needs until a phone call or possible a personal meeting takes place. This wastes the time of both the buyer and the supplier.

Often a buyer may want to reach out to certain segments of suppliers, such as local suppliers, minority owned suppliers, or small businesses. This type of outreach is believed to promote a positive image for the firm doing the outreach. Doing the necessary research to determine which suppliers fall within a given outreach category is also time-consuming as much of the detailed information about the suppliers is not readily available to the public.

### SUMMARY

A system that schedules a meeting with a meeting invitee includes a database that is configured to store records associated with potential meeting participants that meet one or more pre-qualification criteria. A meeting notifier provides notice regarding a future meeting to the potential meeting participants having records in the database. A participant selector applies one or more post-qualification criteria to potential meeting participants who respond to the notice and a meeting scheduler places selected participants on a meeting schedule.

### BRIEF DESCRIPTION OF DRAWINGS

FIG. 1 is a schematic block diagram of an invitee-participant matching system constructed in accordance with an embodiment of the present invention;

FIG. 2 is a flowchart outlining a method that matches invitees and participants for scheduling a meeting;

FIG. 3 is a schematic block diagram of a buyer-supplier matching system constructed in accordance with an embodiment of the present invention;

FIG. 4 is flowchart outlining one procedure for implementing a buyer-supplier matching system constructed in accordance with an embodiment of the present invention;

FIGS. 5-8 are examples of user interface screens that may be used to collect and present information from buyers and suppliers according to an embodiment of the present invention;

FIG. 9 is a schematic block diagram of a supplier management system that may be used to practice an embodiment of the present invention;

FIG. 10 is a schematic table listing database attributes that are included in a supplier database used in practice of an embodiment of the present invention; and

FIG. 11 is a schematic block diagram of a buyer-supplier matching system constructed in accordance with an embodiment of the present invention.

### DESCRIPTION

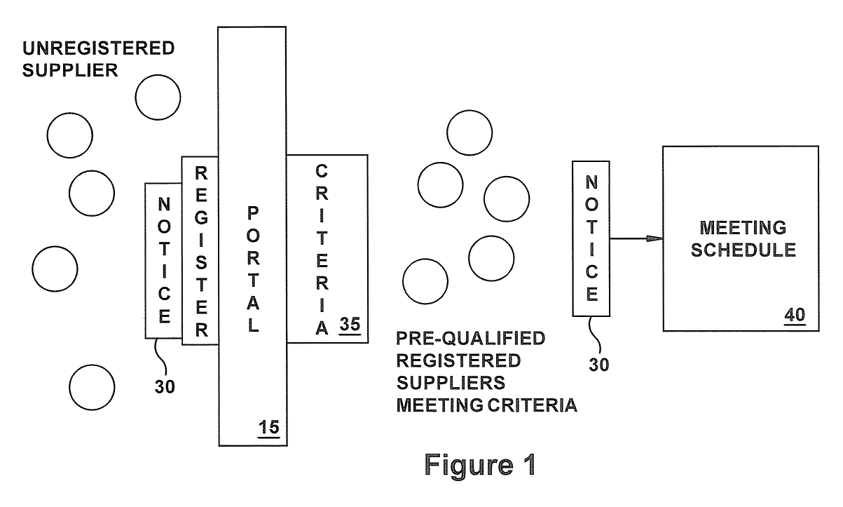

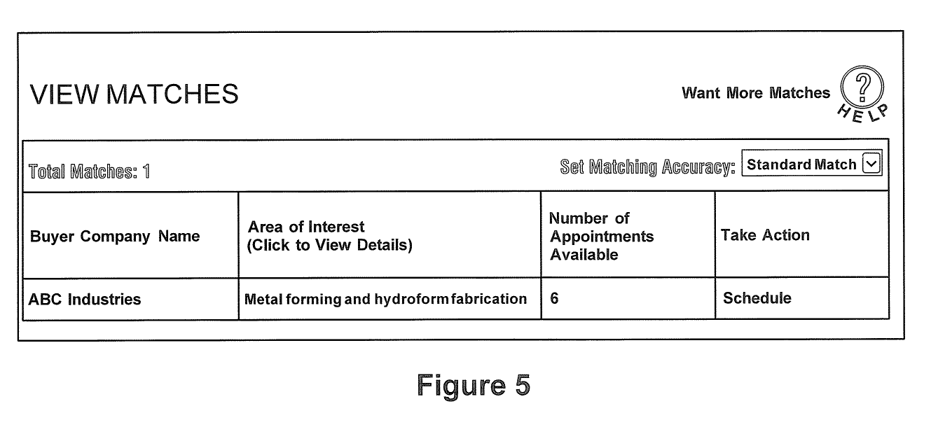

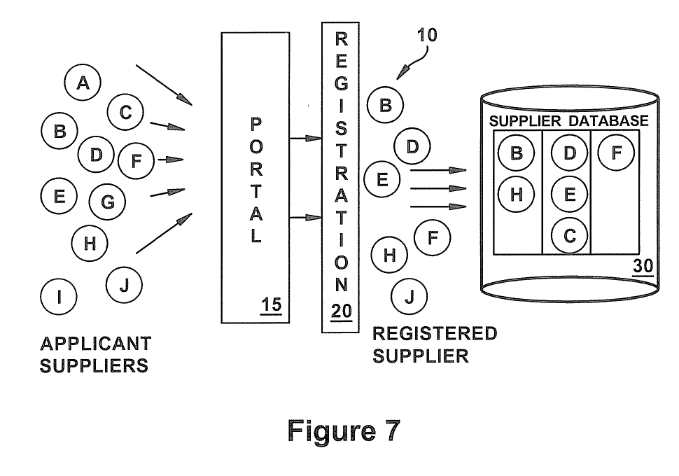

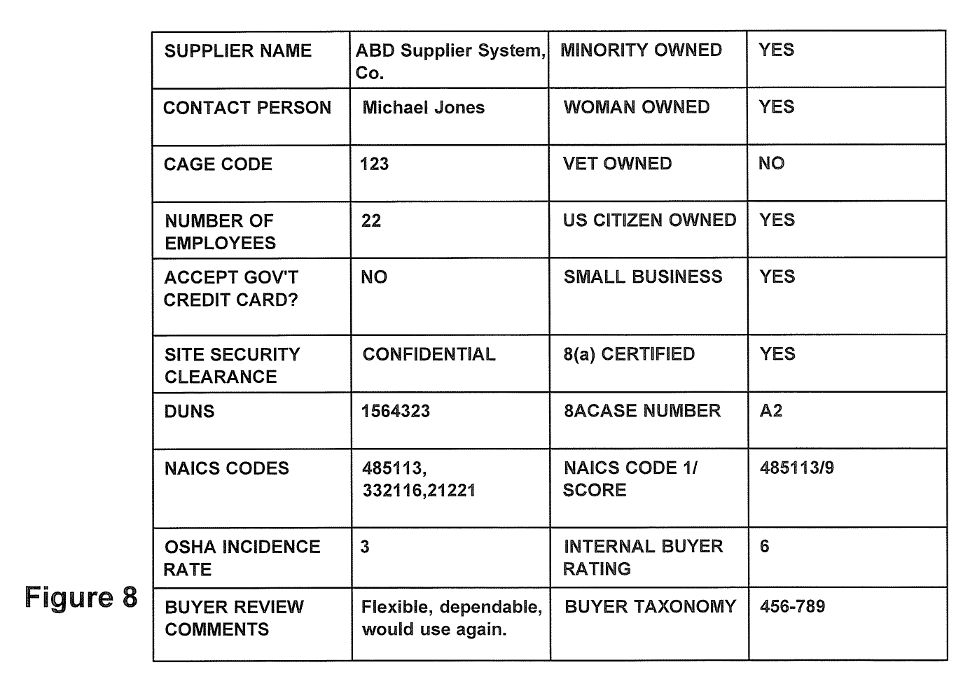

FIG. 1 is a schematic block diagram of an invitee-participant matching system 10 that compiles a meeting schedule with selected potential meeting participants that match an invitee's criteria. The system includes a database 25 that stores records associated with each potential meeting participant. This database may be constructed, for example, by potential meeting participants registering their information at an on-line portal 15. Information collected during the registration process may be stored as attributes in the participant's record. A pre-qualification criteria filter 20 may apply some minimum requirement criteria to the information supplied by registering participants, and the filter 20 may prevent entry of records in the database 25 for participants that do not meet the minimum requirements as indicated by the “X” terminating the path of a registering participant in FIG. 1. A meeting invitee accesses an invitee interface 35 (an example of which is shown in FIG. 5) in which the invitee provides meeting scheduling information to a meeting notifier 45. The meeting notifier provides a meeting notice (an example of which is shown in FIG. 7) with scheduling information to potential participants. The meeting notice may be made available to the public, or it may be sent only to pre-qualified participants already having records in the database. The meeting notice may be, for example, posted on the on-line portal 15. The invitee also inputs one or more post-qualification criteria at the invitee interface 35. The post-qualification criteria may be, for example, an area of expertise being sought. The invitee interface supplies the post-qualification criteria to a participant selector 30 that generates a query to be executed on the database against database records corresponding to potential meeting participants that have responded to the meeting notice. Potential meeting participants whose records are returned by the query are provided to a meeting scheduler 40 that schedules a meeting between the invitee and the participant. In one embodiment, the selected participants are presented with a meeting schedule such as the one shown in FIG. 8 and invited to select a meeting time.

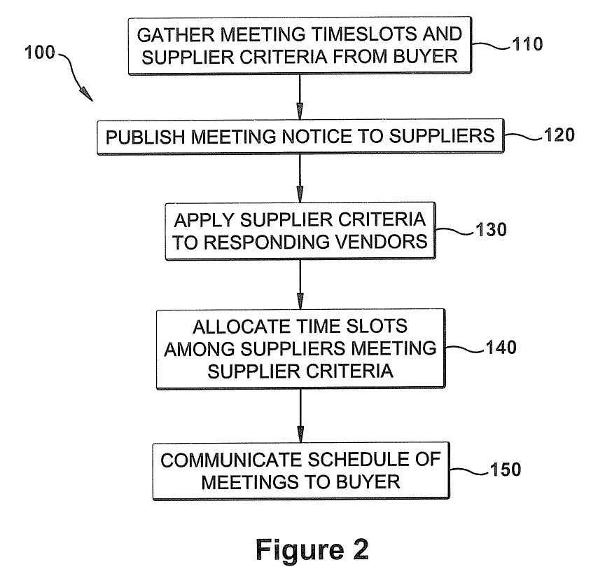

FIG. 2 is a flowchart outlining a method 50 that schedules a meeting between an invitee and one or more potential meeting participants. At 55 a database is populated with potential meeting participants that meet pre-qualification criteria. At 60 a meeting notice is provided to potential meeting participants. At 65 potential meeting participants who respond to the notice are identified. At 70 records associated with each responding participant are identified. At 75 the database is queried to select responding potential meeting participants that meet post-qualification criteria and at 80, the selected participants are invited to the meeting.

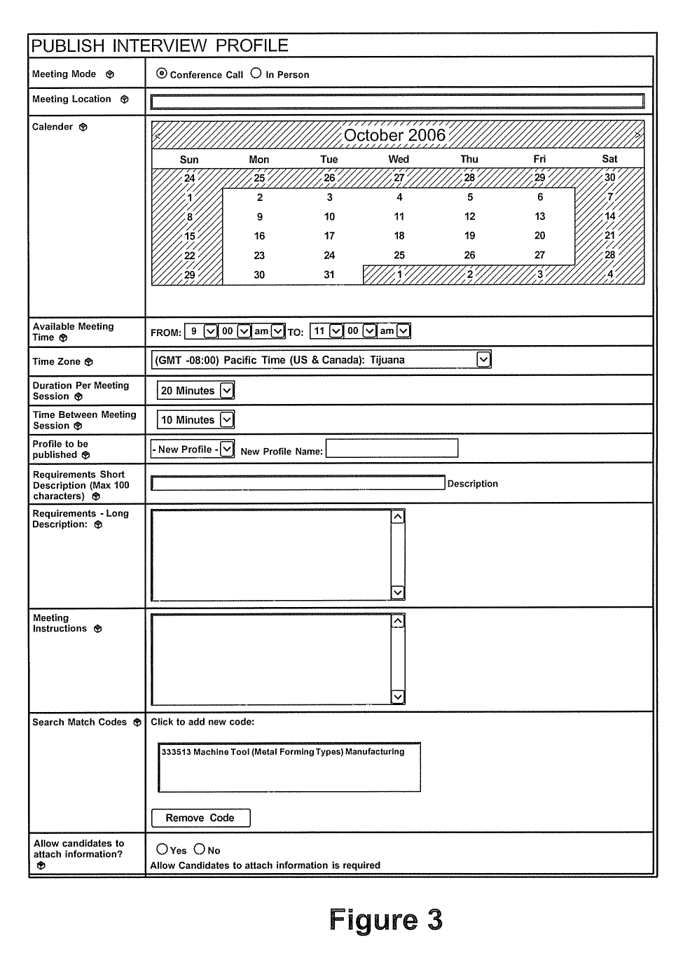

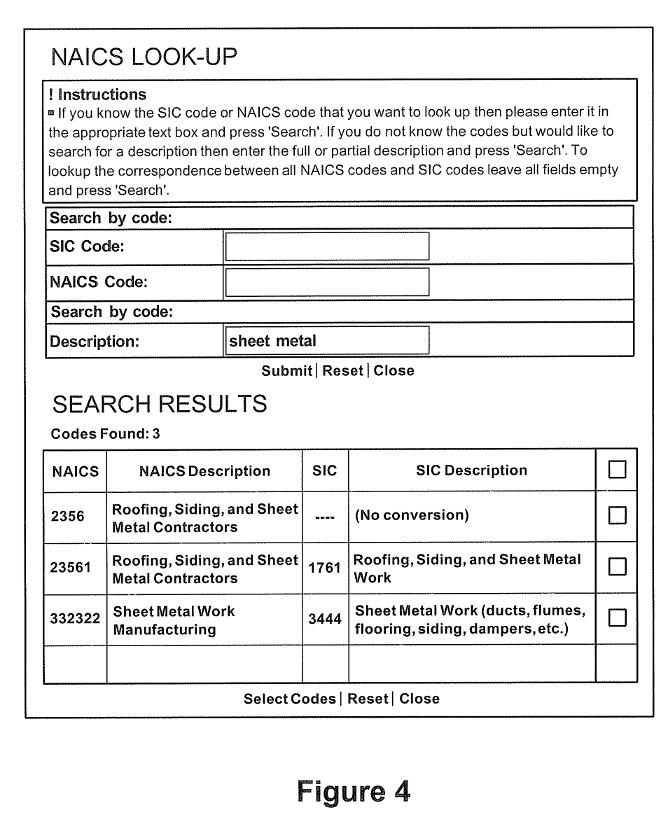

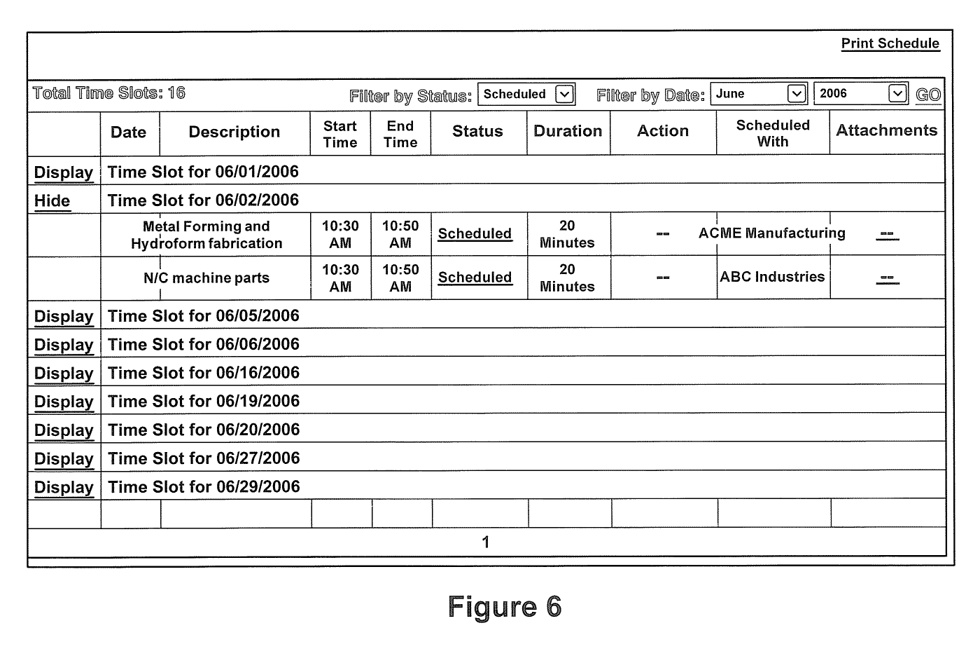

FIGS. 3-11 illustrate invitee-participant matching within the context of a buyer scheduling meetings with several suppliers. It will be apparent to one of skill in that invitee-participant matching may be practice in any context between any type of invitee and participant, according to the present invention. FIG. 3 is a functional block diagram illustrating a buyer-supplier matching system that allows a buyer to schedule meetings on a meeting schedule 140 with suppliers that meet certain criteria. The buyer-supplier matching system may be web-based. The buyer may be searching from a pool suppliers who have information recorded in a supplier database as will be described in more detail in connection with FIGS. 7 and 8, however, any pool of suppliers could be used in practice of the buyer-supplier matching system. The buyer creates a public meeting notice 130 and sets particular meeting criteria 135 using, for example, the screen shown in FIG. 5. The meeting notice 130 includes information that is to be presented to suppliers such as the type of meeting including conference call, in-person, or web meeting. The meeting notice also includes a needs selection that can be performed by entering a plain text description, a codified description such as NAICS, or by selecting from a list of commodities at a qualification or pre-qualification level. Buyer aids may be included such as the commodity code look-up table shown in FIG. 6. The buyer also selects his time availability by selecting a number of meeting time slots on given days and meeting particulars such as meeting duration. The time slots may be of constant duration or may have differing durations. The buyer may also include time between meetings to record notes and prepare for the next meeting or block times out as unavailable for meeting. The buyer may also include instructions as to a format of the meeting, requesting that the supplier send documentation in advance, or any other information that is relevant to the meeting. This information is used to construct the meeting notice, shown functionally as 130 in FIG. 3 and as the screen shown in FIG. 7.

The buyer also includes one or more supplier criteria that must be met in order for the supplier to be scheduled. This supplier criteria is shown functionally as a criteria filter 135 in FIG. 3. These criteria, for example, may target groups of companies for which the buyer is engaging in an outreach effort. For example, the criteria may include a location, company type, owner's ethnicity, certification or a pre-qualification score. Only the suppliers who meet the criteria will be eligible to schedule a meeting in the meeting schedule 140. FIG. 8 is one example meeting schedule screen that can be used to prompt suppliers to schedule a meeting time slot. When a supplier has selected a time slot, the time slot is removed from the list of available meeting times. Once a meeting is scheduled, the supplier may be provided with teleconference information that allows him to call into a teleconference with the buyer at the prescribed time. The supplier may also be given contact information for the buyer at this time. The buyer receives detailed information about the supplier to help him prepare for the meeting. Meeting notices are sent via e-mail to both the buyer and supplier.

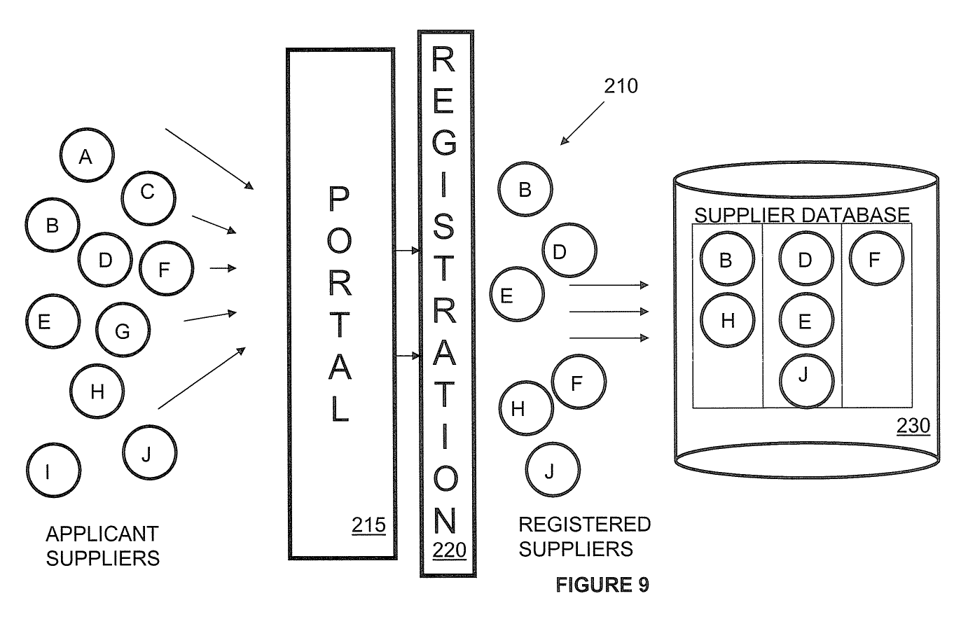

In one embodiment, logged in suppliers can access a matchmaking interface to be presented with information about meetings for which they have a commodity match and match the meeting criteria. The suppliers can view information about the meeting and the buyer and determine whether they wish to schedule a meeting. Another option is to actively notify all suppliers in an existing database, such as, for example, the database 230 in FIG. 9, who meet the buyer's meeting criteria. All suppliers who receive the invitation will be allowed to schedule a meeting. According to another option shown in FIG. 3 the meeting invitation can be made publicly available at a supplier registration portal 115, which will described in more detail in connection with FIG. 9. Any supplier who is unregistered and tries to respond to the invitation is routed to the registration process 120 (FIG. 9) and added to the database. At this point the newly registered suppliers are screened with respect to the criteria and those meeting the criteria are allowed to schedule a meeting. This public invitation approach can assist a buyer in recruiting new suppliers by allowing him to access suppliers not yet in his company's supplier pool.

After the buyer-supplier matching process, the buyer receives a meeting schedule 140 that provides an agenda of meeting times and parties involved. The buyer can be confident that all of the suppliers on the agenda meet his desired criteria. The matching process can be integrated with the workflow of the buyer. After the meetings, the buyer can enter additional qualitative information in the database to include information he learns dining the meeting, such as his personal impression of the supplier or additional products and services the supplier offers and/or assign a score to the supplier. The buyer can complete supplier review forms, follow up with contact information to the supplier, and/or add the supplier to a list for further review. The buyer may also enter the supplier into a due diligence workflow process. The buyer can access reports detailing the history and quantity of meetings conducted including supplier criteria as evidence of outreach to suppliers that meet the criteria, such as minority owned businesses.

Referring to FIG. 9, one exemplary supplier management system 210 in which the buyer-supplier matching system may be implemented is shown in functional block format. The supplier management system that is described herein is implemented as a website. Buyers and suppliers may obtain access to the features available on the website such as, for example, by subscribing to the website or by purchasing transactions that use the website. The supplier management system 210 includes the portal 215 that accepts user credentials and manages access to the website functionality. The portal 215 can route users to a specific buyer's supplier management system or to a general webpage that presents information that may be of interest to potential suppliers to any buyer. Buyers, in this example, are companies that have purchased the supplier management system for use in managing their suppliers. Suppliers may also purchase access to the client's supplier management system on a subscription or per transaction basis.

One feature of the supplier management system 210 is a registration process, shown functionally as block 220, that can be used to prompt suppliers to either provide their credentials as a registered supplier or complete the registration process. The registration process is used to gather extensive information about a supplier in a consistent fashion. Not all suppliers will complete the registration process and may not be given access to the supplier management system. For example, applicant suppliers may enter demographic, address, references and other such data. The applicant supplier also selects one or more specific commodities (products or services). The selection of a commodity may result in solicitation of commodity specific information from the supplier. The supplier's responses to the questions are compared to client-generated criteria for each commodity for which the supplier is seeking registration and the supplier is given a commodity “score” with respect to each commodity for which they sought to register based on the criteria. Filters may be applied to the registering suppliers on a commodity basis, so that the suppliers having at least a minimum score for a given commodity or have not selected any responses that are considered rejection responses are deemed “pre-qualified” for that commodity.

The collected information is used to populate a supplier database 230 that includes attributes corresponding to the types of information solicited from the supplier during registration as well as system-generated attributes, such as the commodity score. The database may be buyer specific and include only those attributes specified by the buyer. Alternatively, the database can be a global database that includes supplier data having both attributes that are of global interest across suppliers and buyer specific attributes such as buyer supplier ratings. The buyer specific attributes may be only accessible by the corresponding buyer. The database includes, among many tables, tables that organize the suppliers on a commodity by commodity basis and includes suppliers that are pre-qualified for each commodity. Buyers can search the database for registered suppliers that have met criteria corresponding to database attributes. Other functional groups within the buyer entity may also access the database for contact information, financial data, or other information about a supplier.

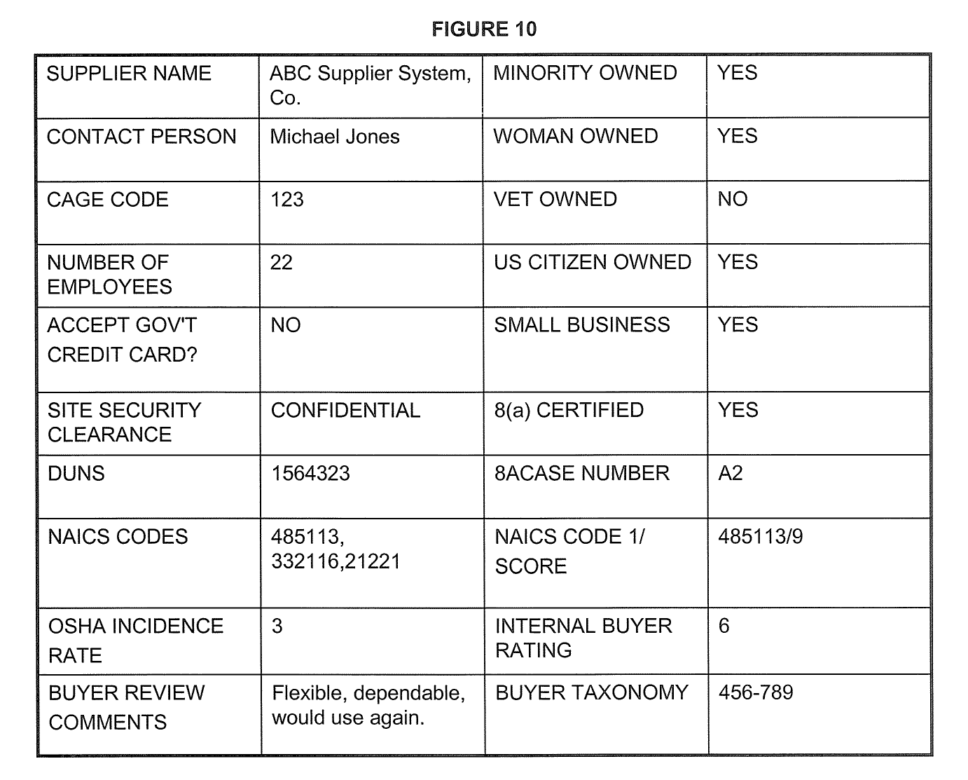

FIG. 10 is a table that outlines a selection of fields from a supplier database. Many of the attributes correspond to information solicited during the registration process and can be tailored by a buyer to their specific needs. As can be seen from the table, contact information and business information such as a DIJNS number may be included. To indicate what commodities the supplier sells, one or more NAICS, UNSPC or other codes are stored for each commodity for which the supplier is pre-qualified. In addition, the buyer may create their own taxonomy for commodities. Other attributes include whether the supplier has a security clearance and accepts government credit cards. Specific information about the ownership and size of the company, such as the number of employees and whether the company is minority owned or recognized as a small business are attributes that are particularly useful in outreach efforts because they help to target a specific outreach group. Safety compliance ratings such as the OSHA incidence rate may be included as attributes to allow the client to manage potential liability and to reach out to suppliers that provide a safe work environment for their employees. Other related attributes could include insurance coverage and various certifications that may be relevant to the supplier selection process. It will be apparent to one of skill in the art that any type of supplier information can be stored in the supplier database.

Some of the attributes are qualitative such as the commodity score, listed as NAICS CODE 1/SCORE in the table. Other qualitative attributes can include an buyer-internal supplier rating which may be an average of individual buyer ratings based on each buyer's experience with the supplier. Such qualitative information gives buyers unfamiliar with a supplier the benefit of other buyers' experience. Comment fields may be available for storing a buyer's comments about interactions with the supplier. For privacy purposes, these comment fields may be protected so that only the buyer who recorded the comment may access the comment. The variety and extent of attributes creates a central repository in which all supplier information may be stored and by all relevant departments of the buyer. Suppliers can be pre-qualified for a given purpose simply by accessing the database and searching on relevant attributes. This allows the buyer to pre-screen without having to contact suppliers directly.

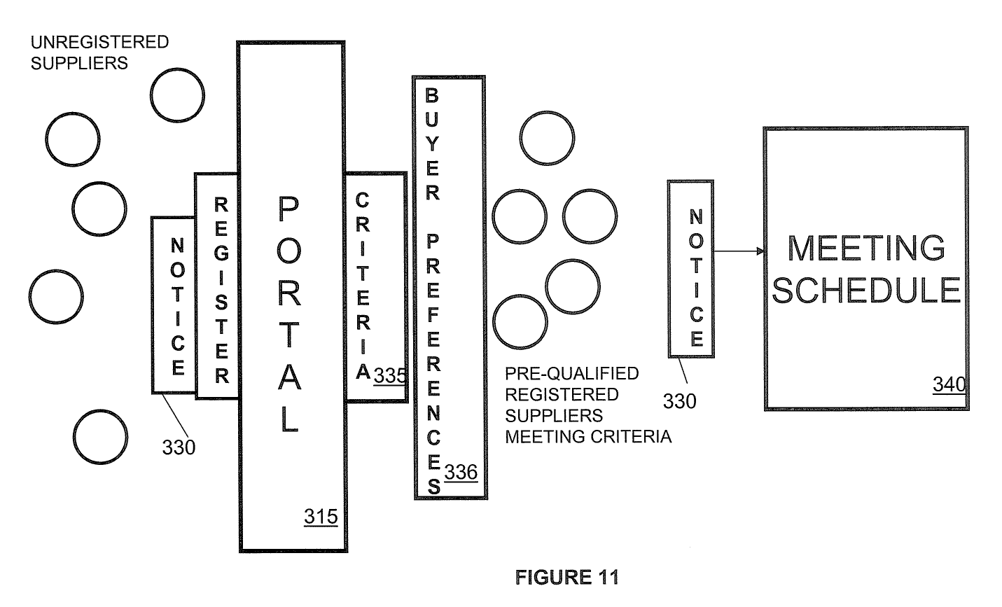

FIG. 11 is a schematic block diagram of a buyer-supplier matching system that includes a buyer preference filter 336 that acts as a filter on pre-qualified registered suppliers who meet the criteria 335. The buyer preference filter may be a preferred supplier list maintained by the buyer. The preferred supplier list may be used to filter out any suppliers who otherwise meet the criteria 335 but who are not on the preferred supplier list. Alternatively, the meeting notice 330 may only be sent to preferred suppliers. Another example of a buyer preference filter is a non-preferred supplier list that may act to eliminate any suppliers on the list from being scheduled.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

1. A system that schedules a meeting with a meeting invitee comprising:
a database configured to store records associated with potential meeting participants that meet one or more pre-qualification criteria, wherein each record includes at least one attribute related to a post-qualification criteria;
a meeting notifier configured to provide notice regarding a future meeting to potential meeting participants having an associated record in the database;
a participant selector configured to apply one or more post-qualification criteria to potential meeting participants responding to the notice; and
a meeting scheduler configured to place selected participants on a meeting schedule.

2. The system of claim 1 comprising an on-line portal that provides an interface for potential meeting participants to populate the database with information pertaining to the potential meeting participant.

3. The system of claim 2 wherein the meeting notifier is configured to publish a meeting notice that is made available on the on-line portal.

4. The system of claim 1 wherein the participant selector comprises a query generator that constructs a query relating to the post-qualification criteria for execution on the database.

5. The system of claim 4 wherein the participant selector comprises an invitee interface for a meeting invitee to specify post qualification criteria for inclusion in the query.

6. The system of claim 1 comprising an invitee preference filter that is applied to potential meeting participants responding to a meeting notice associated with a given invitee.

7. The system of claim 6 wherein the invitee preference filter comprises a list of preferred potential meeting participants.

8. The system of claim 7 wherein the meeting notifier is configured to provide notice exclusively to preferred potential meeting participants.

9. The system of claim 6 wherein the invitee preference filter comprises a list of non-preferred potential meeting participants and wherein the participant selector is configured to not select non-preferred potential meeting participants that otherwise meet the post-qualification criteria.

10. The system of claim 6 wherein the invitee preference filter is applied to potential meeting participants responding to meeting notices from a plurality of invitees.

11. A system that schedules a meeting with a meeting invitee comprising:
a database configured to store records associated with potential meeting participants that meet one or more pre-qualification criteria, wherein each record includes at least one attribute related to a post-qualification criteria;
an on-line participant portal configured to present information to potential meeting participants and to collect data from the potential meeting participants for constructing records in the database.
a meeting notifier configured to provide notice at the on-line portal regarding a future meeting to potential meeting participants having an associated record in the database;
a participant selector that acts on records of potential meeting participants responding to the notice, the participant selector comprising:
an invitee interface for a meeting invitee to specify post qualification criteria to be applied to potential meeting participants; and
a query generator configured to generate a query relating to the one or more post-qualification criteria, wherein the query is executed on the database to return records of potential meeting participants meeting the post-qualification criteria; and
a meeting scheduler configured to place selected participants on a meeting schedule.

12. The system of claim 11 comprising an invitee preference filter that is applied to potential meeting participants responding to a meeting notice associated with a given invitee.

13. The system of claim 12 wherein the invitee preference filter comprises a list of preferred potential meeting participants.

14. The system of claim 13 wherein the meeting notifier is configured to provide notice exclusively to preferred potential meeting participants.

15. The system of claim 12 wherein the invitee preference filter comprises a list of non-preferred potential meeting participants and wherein the participant selector is configured to not select non-preferred potential meeting participants that otherwise meet the post-qualification criteria.

16. The system of claim 12 wherein the invitee preference filter is applied to potential meeting participants responding to meeting notices from a plurality of invitees.
